(19) United States
(12) Patent Application Publication
(10) Pub. No.: US 2009/0046814 A1
(43) Pub. Date: Feb. 19, 2009

(54) IN-PHASE SIGNAL AND QUADRATURE SIGNAL GENERATOR OF MULTI-PORT NETWORK

(75) Inventors: Sang Yub LEE, Seongnam (KR); Chang Soo Yang, Seongnam (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 12/190,254

(22) Filed: Aug. 12, 2008

(30) Foreign Application Priority Data
Aug. 13, 2007 (KR) 10-2007-0081204

(51) Int. Cl. H04L 27/18

(52) U.S. Cl. 375/322

(57) ABSTRACT

An in-phase signal and quadrature signal generator of multi-port network can generate an in-phase (I) signal and a quadrature (Q) signal using a matrix according to a rate of powers detected from signals from a multi-port network.

An I/Q signals generator of multi-port network includes a multi input/output unit configured to down convert a RF signal into a plurality of phase signals having different phase according to a predetermined reference frequency signal to detect the powers of the phase signals, and an I/Q signal generating unit configured to generate the power distribution rate of the phase signals according to the detected powers, and convert the phase signals from the multi input/output unit into an I signal and a Q signal according to the power distribution rate.

### CROSS-REFERENCE TO RELATED APPLICATIONS

This application claims the priority of Korean Patent Application No. 2007-0081204 filed on Aug. 13, 2007, in the Korean Intellectual Property Office, the disclosure of which is incorporated herein by reference.

### BACKGROUND OF THE INVENTION

1. Field of the Invention

The present invention relates to an in-phase signal and quadrature signal generator of multi-port network, and more particularly, to an in-phase signal and quadrature signal generator of multi-port network which can generate an in-phase (I) signal and a quadrature (Q) signal using a matrix according to a rate of powers detected from signals from a multi-port network.

2. Description of the Related Art

In general, since a radio frequency (RF) receiver having a multi-port network including multi input/output port such as a 5-port network or 6-port network consumes far less power than a RF receiver with the existing active device and may have broadband characteristics, it is suitable for a structure of a software defined radio (SDR) receiver. A SDR technology denotes a wireless access technology for integrating and introducing a plurality of wireless communication standard through a single transceiving system by only changing software which is modulized on the basis of a high-tech digital signal processing technology, a system software technology and a high performance digital signal processing device without the correction of hardware.

FIG. 1 is a block diagram of the related art in-phase/quadrature signals generator of multi-port network.

Referring to FIG. 1, the related art in-phase/quadrature signals generator of multi-port network 10 includes a multi-port network 11, an initial value calculating unit 12, and an in-phase (I)/quadrature (Q) signals generating unit 13.

To set an initial parameter value, the related art I/Q signals generator 10 calculates each of phase signals from the multi-port network 11, or compares a previous phase signal with a current phase signal to correct a gain between the phase and path of the phase signal, thereby performing a feedback. Accordingly, the related art I/Q signals generating unit 10 minimizes a noise value occurring in the path.

The related art I/Q signals generator 10 takes a long time in calculating an initial value, and adopts a structure which should use both a signal pre-process and a information signal for calculating the initial value.

Moreover, since symmetry is not secured according to the radio frequency (RF) signal and channel characteristics of a transceiving module of the RF signal, it is difficult to calculate accurately. To solve this, a separate calculation circuit and a separate operation process are required. In addition, a feedback of a signal also requires an additional buffer. Furthermore, in a case where a quantity of processing data increases, a size of the buffer increases so that a price of a product and a complexity of a circuit increase.

In particular, an accurate phase change and gain conditions are required which have the same difference between the phase signals of each of three paths of the phase signals from the multi-port network 11. That is, when there is a constant phase difference of 90 degrees or 180 degrees between the phase signals, the phase signals can be demodulated to an I signal and a Q signal.

An I signal and a Q signal by the related art I/Q signals generator will be described with reference to FIG. 2.

FIG. 2 is a graph illustrating the distributions of I/Q signals generated by an I/Q signals generator of multi-port network of FIG. 1.

Referring to FIG. 2, since an I signal and a Q signal by the related art I/Q signals generator 10 do not have a constant phase and gain between the phase signals of each of paths from the multi-port network 11, it can be seen from FIG. 2 that it is difficult to discriminate the distributions of the I signal and the Q signal.

### SUMMARY OF THE INVENTION

An aspect of the present invention provides an in-phase signal and quadrature signal generator of multi-port network, which can generate an in-phase (I) signal and a quadrature (Q) signal using a matrix according to a rate of powers detected from signals from a multi-port network without complex operation processes, and thus specifically discriminate a phase difference between the I signal and the Q signal even when a phase of each of paths from the multi-port network is not constant.

According to an aspect of the present invention, there is provided an I/Q signals generator of multi-port network which includes: a multi input/output unit configured to down convert a RF signal into a plurality of phase signals having different phase according to a predetermined reference frequency signal to detect the powers of the phase signals; and an I/Q signal generating unit configured to generate the power distribution rate of the phase signals according to the detected powers, and convert the phase signals from the multi input/output unit into an I signal and a Q signal according to the power distribution rate.

According to another aspect of the present invention, there is provided the I/Q signals generating unit which may generate a matrix corresponding to the power distribution rate by applying the detected powers to a singular value decomposition scheme, and perform a pseudo inverse matrix of the matrix to convert the phase signals into the I signal and the Q signal.

According to still another aspect of the present invention, there is provided the I/Q signals generating unit which may generate a matrix corresponding to the power distribution rate by applying the detected powers to an eigen decomposition scheme, and perform a pseudo inverse matrix of the matrix to convert the phase signals into the I signal and the Q signal.

According to still another aspect of the present invention, there is provided the multi input/output unit which may include: a multi-port network configured to shift a phase of the RF signal to divide into a plurality of signals, and mix the divided signals with the reference frequency signal to convert them into the phase signals; and a power detector configured to detect the powers of the phase signals from the multi-port network.

According to still another aspect of the present invention, there is provided the multi input/output unit which may further include: a filter configured to filter the respective phase signals from the power detector to a predetermined frequency band; and an A/D converter configured to convert the respective phase signals from the filter into digital signals.

According to still another aspect of the present invention, there is provided the I/Q signal generating unit which may be software included in at least one integrated chip.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of the related art in-phase/quadrature signals generator of a multi-port network;

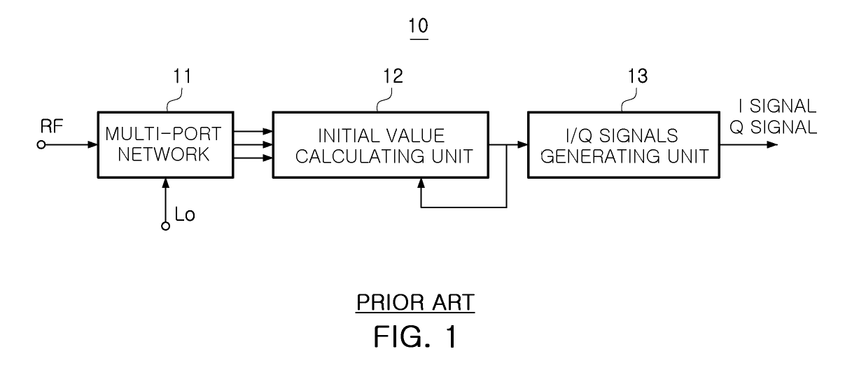

FIG. 2 is a graph illustrating the distributions of I/Q signals generated by an I/Q signals generator of multi-port network of FIG. 1;

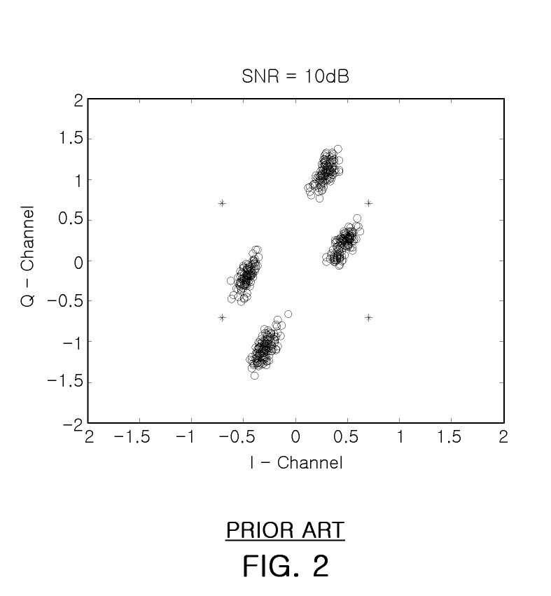

FIG. 3 is a block diagram of an in-phase signal and quadrature signal generator of multi-port network according to an embodiment of the present invention; and

FIG. 4 is a graph illustrating the distributions of an I signal and a Q signal generated by an I/Q signals generator of multi-port network according to the present invention.

### DETAILED DESCRIPTION OF THE PREFERRED EMBODIMENT

Exemplary embodiments of the present invention will now be described in detail with reference to the accompanying drawings.

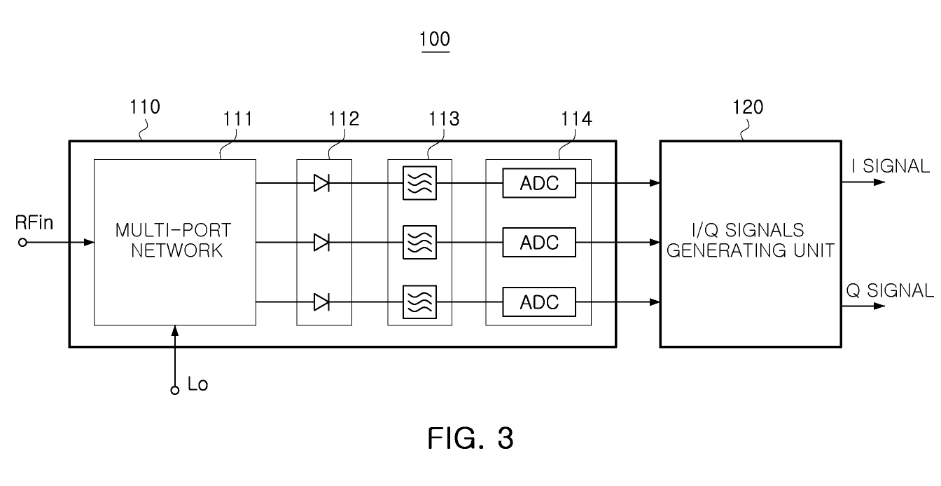

FIG. 3 is a block diagram of an in-phase signal and quadrature signal generator of multi-port network according to an embodiment of the present invention.

Referring to FIG. 3, an in-phase signal and quadrature signal generator of multi-port network 100 of the present invention includes a multi-port input/output unit 110 and a in-phase (I)/quadrature (Q) signals generating unit 120.

The multi-port input/output unit 110 may include a multi-port network 111, a power detector 112, a filter 113, and an analog-to-digital (A/D) converter 114.

The multi-port network 111 may be configured with a 5-port network having a radio frequency signal RFin input terminal, a predetermined reference frequency signal Lo input terminal and three phase signal output terminals or a 6-port network having a RF signal input terminal, a predetermined reference frequency signal input terminal and four phase signal output terminals. FIG. 3 illustrates the 5-port network as an example.

The multi-port network 111 divides the RF signal into a plurality of signals, shifts a phase of the reference frequency signal, and mixes the shifted reference frequency signal with the signals to output a plurality of phase signals.

The power detector 112 detects the powers of the phase signals from the multi-port network 111.

The filter 113 filters the phase signals from the power detector 112 to a predetermined frequency band, and the A/D converter 114 converts the phase signals from the filter 113 into digital signals

The I/Q signals generating unit 120 converts the phase signals from the multi input/output unit 110 into a I signal and a Q signal according to a matrix set by the detected powers.

As illustrated in FIG. 3, the multi input/output unit 110 transfers phase signals having different phase to the I/Q signals generating unit 120 through three paths.

Assumed that a phase signal of a first path of the above-described three paths is y₁(k), the phase signal y₁(k) of the first path is expressed as Equation (1) below.

$${y}_{1} ( k ) = {A}_{1} ( {χ}_{I}^{2} ( k ) + {χ}_{Q}^{2} ( k ) + {G}_{1}^{2} ) + {A}_{2} ( {χ}_{I} ( k ) {G}_{1} cos ( {ϕ}_{1} ( k ) ) + {χ}_{Q} ( k ) {G}_{1} sin ( {ϕ}_{1} ( k ) ) + {n}_{1}^{′ } \qquad ( 1 )$$

where A₁ and A₂ represent a magnitude of a signal, G₁ represents a gain, and φ₁ represents a phase. Moreover, n₁′ denotes a noise component of a signal, and X_{I}(k) and X_{Q}(k) represent an I signal and a Q signal respectively.

Likewise, a phase signal y₂(k) of a second path and a phase signal y₂(k) of a third path may be expressed as the Equation (1). When the three phase signals are equated as a matrix, which is expressed as Equation (2) below.

$$[ \begin{matrix}{y}_{1} ( k ) \\ {y}_{2} ( k ) \\ {y}_{3} ( k )\end{matrix} ] = {A}_{2} [ \begin{matrix}{G}_{1} cos ( {ϕ}_{1} ( k ) ) & {G}_{1} sin ( {ϕ}_{1} ( k ) ) & 0.5 \\ {G}_{2} cos ( {ϕ}_{2} ( k ) ) & {G}_{2} sin ( {ϕ}_{2} ( k ) ) & 0.5 \\ {G}_{3} cos ( {ϕ}_{2} ( k ) ) & {G}_{3} sin ( {ϕ}_{3} ( k ) ) & 0.5\end{matrix} ] \times [ \begin{matrix}{χ}_{1} ( k ) \\ {χ}_{Q } ( k ) \\ {χ}_{I}^{2} ( k ) + {χ}_{Q}^{2} ( k )\end{matrix} ] + {A}_{1} [ \begin{matrix}{G}_{1}^{2} \\ {G}_{2}^{2} \\ {G}_{3}^{3}\end{matrix} ] + [ \begin{matrix}{n}_{1}^{′} \\ {n}_{2}^{′} \\ {n}_{3}^{′}\end{matrix} ] \qquad ( 2 )$$

The I/Q signals generating unit 120 considers a matrix expressed as Equation (3) below.

$$[ \begin{matrix}{G}_{1} cos ( {ϕ}_{1} ( k ) ) & {G}_{1} sin ( {ϕ}_{1} ( k ) ) & 0.5 \\ {G}_{2} cos ( {ϕ}_{2} ( k ) ) & {G}_{2} sin ( {ϕ}_{2} ( k ) ) & 0.5 \\ {G}_{3} cos ( {ϕ}_{3} ( k ) ) & {G}_{3} sin ( {ϕ}_{3} ( k ) ) & 0.5\end{matrix} ] \qquad ( 3 )$$

The above-described Equation (3) is a portion of the Equation (2), and has the phase information and gain information of each of the three phase signals. A desired information can be obtained from the matrix of the Equation (3) by using a singular value decomposition (SVD) scheme or an eigen decomposition (ED) scheme.

The ED scheme may be used to demodulate an I signal and Q signal to discriminate the distributions of the I/Q signals, but may be applied only to a square matrix and extract an inaccurate information. Accordingly, it is preferable to apply the SVD scheme which may be applied to matrix other than the square matrix and extract a more accurate information.

To apply to the SVD scheme, the following Equation (4) is used in the matrix of the Equation (3).

$${A}^{′} = [ \begin{matrix}{G}_{1} cos ( {ϕ}_{1} ( k ) ) & {G}_{1} sin ( {ϕ}_{1} ( k ) ) \\ {G}_{2} cos ( {ϕ}_{2} ( k ) ) & {G}_{2} sin ( {ϕ}_{2} ( k ) ) \\ {G}_{3} cos ( {ϕ}_{2} ( k ) ) & {G}_{3} sin ( {ϕ}_{3} ( k ) )\end{matrix} ] \qquad ( 4 )$$

The above-described Equation (4) is a matrix in which the constant row described as 0.5 in the Equation (3) is removed. This is for obtaining the more accurate power distributions of the phase signals.

The matrix of the Equation (4) can be decomposed into U, S and V according to the SVD scheme, wherein S is formation associated with the power rate of the phase signals. The reason that the Equation (3) is changed into the Equation (4) is because it can be seen through the SVD scheme that the Equation (4) includes information associated with the power rate.

The SVD scheme is expressed as FIG. 5.

A=USV^{T} (5)

Herein, a pseudo inverse matrix is obtained from the Equation (4) in order to obtain two signals, which are the I/Q signals respectively, from the three phase signals.

The pseudo inverse matrix obtained from the Equation (4) is applied to the generation of the I/Q signals as the following Equation (6).

$$[ \begin{matrix}{χ}_{1} ( k ) \\ {χ}_{Q } ( k )\end{matrix} ] = {A}^{+} [ \begin{matrix}{y}_{1} ( k ) \\ {y}_{2} ( k ) \\ {y}_{3} ( k )\end{matrix} ] \qquad ( 6 )$$

As described above, a matrix A′ is obtained from information of the phase signal according to the SVD scheme, and the pseudo inverse matrix A⁺ of the matrix A′ is obtained. The I/Q signals can be obtained by multiplying the phase signal by the pseudo inverse matrix A⁺.

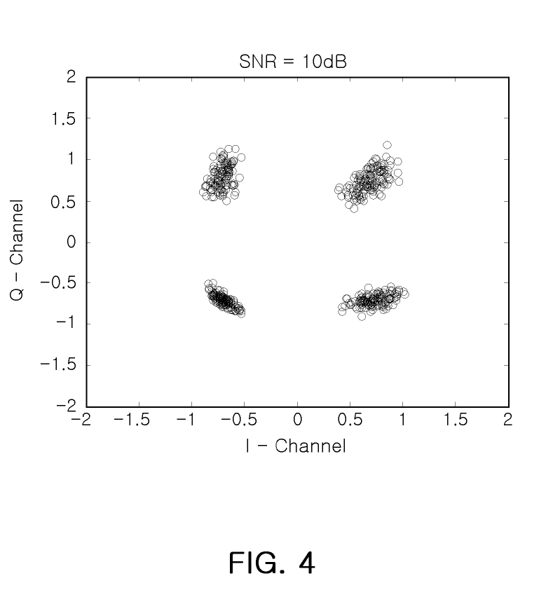

FIG. 4 is a graph illustrating the distributions of an I signal and a Q signal generated by an I/Q signals generator of multi-port network according to the present invention.

As described above, it can be seen from FIG. 4 that the matrix is obtained from information of the phase signal according to the SVD scheme and the pseudo inverse matrix of the matrix is obtained, and thereafter the I/Q signals are distributed to be specifically discriminated by multiplying the phase signal by the pseudo inverse matrix.

The in-phase signal and quadrature signal generator of multi-port network according to the present invention detects the powers of plural phase signals from the multi-port network to change the phase signals into an I signal and a Q signal according to a matrix by the detected powers, and thus can generate the I/Q signals which do not have a miss match even when a phase change between the phase signals is not constant. Accordingly, an initial value generating process for generating the I/Q signals is omitted so that the in-phase signal and quadrature signal generator of multi-port network do not adopt an additional circuit, and consequently the in-phase signal and quadrature signal generator of multi-port network makes the configuring of the circuits of a product ease and decreases volume of the product.

While the present invention has been shown and described in connection with the exemplary embodiments, it will be apparent to those skilled in the art that modifications and variations can be made without departing from the spirit and scope of the invention as defined by the appended claims.

What is claimed is:

1. An I/Q signals generator of multi-port network, comprising:
a multi input/output unit configured to down convert a RF signal into a plurality of phase signals having different phase according to a predetermined reference frequency signal to detect the powers of the phase signals; and
an I/Q signal generating unit configured to generate the power distribution rate of the phase signals according to the detected powers, and convert the phase signals from the multi input/output unit into an I signal and a Q signal according to the power distribution rate.

2. The generator of claim 1, wherein the I/Q signals generating unit generates a matrix corresponding to the power distribution rate by applying the detected powers to a singular value decomposition scheme, and performs a pseudo inverse matrix of the matrix to convert the phase signals into the I signal and the Q signal.

3. The generator of claim 1, wherein the I/Q signals generating unit generates a matrix corresponding to the power distribution rate by applying the detected powers to an eigen decomposition scheme, and performs a pseudo inverse matrix of the matrix to convert the phase signals into the I signal and the Q signal.

4. The generator of claim 1, wherein the multi input/output unit comprises:
a multi-port network configured to shift a phase of the RF signal to divide into a plurality of signals, and mix the divided signals with the reference frequency signal to convert them into the phase signals; and
a power detector configured to detect the powers of the phase signals from the multi-port network.

5. The generator of claim 4, wherein the multi input/output unit further comprises:
a filter configured to filter the respective phase signals from the power detector to a predetermined frequency band; and
an A/D converter configured to convert the respective phase signals from the filter into digital signals.

6. The generator of claim 1, wherein the I/Q signal generating unit is software included in at least one integrated chip.
